(19) United States
(12) Patent Application Publication
(10) Pub. No.: US 2008/0005915 A1
(43) Pub. Date: Jan. 10, 2008

(54) Flexible measuring tape

(76) Inventors: Jesse A. Jolin, Bristow, VA (US); Jerry Jolin, Bristow, VA (US)

Correspondence Address: SUNG I. OH, PROFESSIONAL LAW CORPORATION, 710 QUAIL VALLEY LANE, WEST COVINA, CA, 91791, US

(21) Appl. No.: 11/482,004

(22) Filed: Jul. 6, 2006

(51) Int. Cl. B43L 7/00

(52) U.S. Cl. 33/493

(57) ABSTRACT

A flexible tube is in the form of an electrical conduit or the like has measurements imprinted thereon. The ruler can be flexed and placed in the exact location and positions that will be occupied by a flexible conduit or cable and will traverse exactly the same distance as the installed conduit or cable.

### TECHNICAL FIELD OF THE INVENTION

The present invention relates to the general art of geometric instruments, and to the particular field of measuring devices.

### BACKGROUND OF THE INVENTION

When installing runs of pipe or conduit, it is desirable to have accurate measurements before cutting the pipe to length and either terminating the end of the pipe or installing a coupling. Electricians find accurate measurements extremely important when installing conduit where one end must land in a coupling or termination box. Proper measurement before cutting guards against waste, improper fitting, and lost work time. To facilitate quick and accurate measurements to be taken it has been, and currently is, the practice of many pipe and conduit installers to have an assistant hold the end of a tape measure at one end of the pipe while the installer himself extends the tape measure and marks the pipe at the point where a cut is to be made. Use of an assistant, however, increases the cost of installation. As a result, several solutions have been proposed for attaching the end of a tape measure to a pipe, thereby eliminating the need for an assistant.

For example, there are devices which permit a tape to be inserted into a pipe and which have a measurement index on the tape which remains in place when the tape is removed as well as devices which include tape measure spools in combination with arcuate-shaped apparatus for attachment of a tape measure to the end of a length of pipe and the like.

The devices known to the inventor are deficient in one or more important respects. Some are bulky and not well suited for use with small diameter pipes, and do not fit into a small tool box or the installer's pocket for easy field use. Others require a coupling or end cap to be installed on the pipe so that the device can be secured to the pipe. Still others are not adaptable for attachment to pipes of varying diameters. Further, none of the devices disclosed permit the installer to easily change the direction of measurement.

Still further, when installing conduit to house runs of conductors, the installer inevitably will need to make bends in the conduit run in order to navigate around obstacles. Bends of various shapes are usually needed, such as right angle or 90-degree bends, offsets and saddles. Most, if not all, of these bends will be made on the job as part of the installation procedure and are, therefore, known as field bends.

Before these field bends are actually made, it is essential that the installer do some careful planning. As each bend in the run adds to the friction caused when pulling the conductors, the NEC allows for only a total of 360 degrees of bends between pull points. As more bends are made, more pull points are required. This accordingly will affect the required labor to install the conductors, and ultimately affects the schedules and profits of the job. Therefore, it is good practice for the installer to walk the entire route before any conduit is installed, especially when dealing with longer runs with difficult conductor installation.

The schedules and profits of the job are further affected by the labor and material costs involved in the installation of the conduit, and, as such, accurate measurements arc crucial. While installing electrical conduit for example, it will be necessary to calculate the correct length for a specific run. Because most installations are typically not straight runs, these bends must be made to navigate around obstructions to ensure a precise fit. When two opposing bends that are equal in the degree of their angle are used to clear an obstacle and maintain a course parallel to the original course, it is called an offset bend. In other words, and assuming both bends have the same angle measure, an offset bend is used when an obstruction requires a change in the conduits' plane.

Before making an offset bend, the installer must choose the most appropriate angle for the offset. Although this angle may be primarily chosen with respect to the offset depth, shallow bends will make for easier conductor pulling, while steeper bends will conserve space. Additionally, the installer must also consider that the conduit will shrink due to this detour. This shrinkage or take-up may possibly be ignored if working away from the obstruction, but certainly must be considered when working into the obstruction.

After the installer determines the offset depth and offset angle necessary to clear the obstacle, he will then typically refer to an offset multiplier table to calculate the required distance between conduit bends to achieve the desired dimensions.

Tables can aid the installer that encounters the prescribed offset angles depicted by such tables. However, if the installer encounters an offset angle that is not depicted in his table, he must either approximate the measurement or determine the exact distance between bends through the use of trigonometry. As the multiplier constant in these tables is the cosecant of the angle of offset, a complete chart of Natural Trigonometric Functions illustrates all of the constants for any particular degree of offset. Obviously, such a complete chart would hinder the installer at the job site, so smaller tables illustrating the most common offset angles are more commonplace.

In any event, this procedure, when used properly, may be an adequate method for the offset bending of conduit runs, but it is often time consuming to refer to tables and make calculations as well as prone to error due to careless approximations. Whenever a mistake is made installing conduit it costs money both in the form of labor and materials. An invention that eliminates this error would be most beneficial to the art because it would eliminate the waste and added expense caused by such errors.

Therefore, there is a need for a measuring instrument that can be used to accurately and efficiently measure the length of a run over which a pipe or conduit is to extend.

### SUMMARY OF THE INVENTION

The above-discussed disadvantages of the prior art are overcome by a flexible tube that is in the form of an electrical conduit or the like and which has measurements imprinted thereon. The ruler can be flexed and placed in the exact location and positions that will be occupied by a flexible conduit or cable and will traverse exactly the same distance as the installed conduit or cable. In this manner, the exact distance that will be covered by the installed cable or conduit will be measured by the ruler of the present invention. The exact length of the raw stock

Other systems, methods, features, and advantages of the invention will be, or will become, apparent to one with skill in the art upon examination of the following figures and detailed description. It is intended that all such additional systems, methods, features, and advantages be included within this description, be within the scope of the invention, and be protected by the following claims.

### BRIEF DESCRIPTION OF THE DRAWING FIGURES

The invention can be better understood with reference to the following drawings and description. The components in the figures are not necessarily to scale, emphasis instead being placed upon illustrating the principles of the invention. Moreover, in the figures, like referenced numerals designate corresponding parts throughout the different views.

FIG. 1 is a perspective view of a flexible ruler embodying the present invention.

FIG. 2 is a view taken along line A-A of FIG. 1.

FIG. 3 shows a detail of FIG. 1.

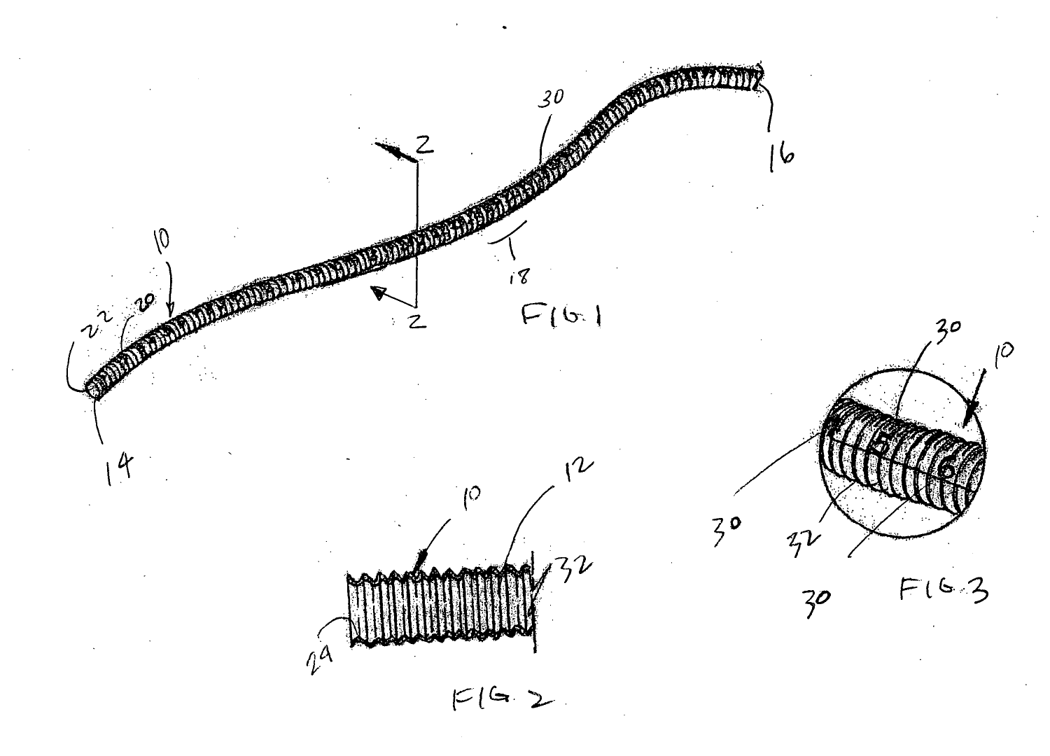

### DETAILED DESCRIPTION OF THE INVENTION

Referring to the figures, it can be understood that the present invention is embodied in a flexible ruler 10. Ruler 10 comprises flexible tube 12 which has a first end 14, a second end 16 and a length dimension 18 which extends between the first end and the second end. Ruler 10 is of undefined length. Ruler 10 further includes an outer surface 20 and an inner surface 22.

A bore 24 is defined by the inner surface and extends in the direction of the length dimension. In one form of the ruler, the tube does not include a bore. A plurality of marking indicia 30 are located on the outer surface. The marking indicia are spaced apart from each other in the direction of the length dimension. The marking indicia can be inch markers, centimeter markers, or the like.

A multiplicity of ribs 32 are defined on the ruler to enable that ruler to bend and twist.

Ruler 10 is used by laying it along the run of a proposed conduit or cable, bending and distorting the ruler in the exact manner the cable or conduit will bend or distort, and then reading the indicia to determine the exact length of the run. The ruler will hold its shape, even when distorted, long enough to match the shape and length of the run. The ruler can then be straightened out after taking the measurement so it can be used for another measurement.

While various embodiments of the invention have been described, it will be apparent to those of ordinary skill in the art that many more embodiments and implementations are possible within the scope of this invention. Accordingly, the invention is not to be restricted except in light of the attached claims and their equivalents.

What is claimed is:

1. A flexible ruler comprising:
A) flexible tube having
(1) a first end,
(2) a second end,
(3) a length dimension which extends between the first end and the second end,
(4) an outer surface,
(5) an inner surface, and
(6) a bore which is defined by the inner surface and which extends in the direction of the length dimension; and
B) a plurality of marking indicia on the outer surface, the marking indicia being spaced apart from each other in the direction of the length dimension.

2. The flexible ruler defined in claim 1 wherein the tube further includes a multiplicity of ribs.

3. A flexible ruler comprising:
A) flexible body having
(1) a first end,
(2) a second end,
(3) a length dimension which extends between the first end and the second end, and
(4) an outer surface;
B) a plurality of marking indicia on the outer surface, the marking indicia being spaced apart from each other in the direction of the length dimension; and
C) a multiplicity of ribs defined in the body.
